(19) United States
(12) Patent Application Publication
(10) Pub. No.: US 2016/0353910 A1
(43) Pub. Date: Dec. 8, 2016

(54) Individual Stair Carpets

(71) Applicant: Sandra S. Vergez, Colorado Springs, CO (US)

(72) Inventor: Sandra S. Vergez, Colorado Springs, CO (US)

(21) Appl. No.: 14/728,193

(22) Filed: Jun. 2, 2015

(51) Int. Cl. A47G 27/02; F16B 47/00

(52) U.S. Cl. CPC A47G 27/0287; F16B 47/003

(57) ABSTRACT

The present invention relates to a replaceable damage-free carpet for a stair-step comprising of non-skid carpet material upper portion and a rubber lower portion. The carpet can be used to prevent slipping in commercial buildings and residential dwellings. Glue or double-sided tape can be used to attach the carpet to the stairs. The carpet can be used for decorating purposes. It is 11″×34″ each.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

The present invention relates to carpet. More specifically, the present invention relates to a carpet for individual steps of stairs that protects users from slipping from the stairs and permits people to use stair steps more safely.

### BACKGROUND OF INVENTION

Stairs consist of steps retained by side supports. A step typically consists of a horizontal member, or tread, and a vertical member, or riser. In some instances, stairs are constructed without risers. Therefore, the steps consist of only treads supported on each side by a support. The stair treads may be made from a variety of materials, including wood, stone, plastic, or other natural and man-made material. In all cases, it has been found advantageous to provide a tread covering. A tread covering can provide a safety aspect associated with the use of the stairs.

There has been identified a problem of slipping, particularly while walking fast or running Slipping is also a risk for the elderly and young children. To overcome these problems, various solutions have been developed. Typical tread coverings include carpet, rubber, or similar components that are physically attached to the stair tread, creating holes in the treads. There is a prior art which provides a step cover consisting of a sheet or slab of vulcanized rubber or gutta-percha beveled on all four edges and contained within a frame. The frame is composed of overlapping and beveled strips that are secured together by screws.

Another staircase protection product, for example, is an enclosing mat that uses a soft material to cover the edge and acute part of the stair-step in a manner slightly that is protruding upward, so as to try to attain the purpose of tumbling protection and alleviating impinge force of the edge or acute angle of the stair on the human foot. Such a protection mode may be effective for an adult, but it is of no use to children because children usually do not go step by step orderly when climbing up and down the stairs as an adult does. Instead, children typically leap in a rather disorderly and staggering way, in case when his/her foot just stumbles on the protruded portion of the stair edge, an immediate hazard might occur.

There is a removable non-skid step pad in the market today that covers a portion of a corresponding step of an exterior stair or staircase so as to allow people to use it more safely. The pad is comprised of a main section to be disposed on the upper horizontal portion of the step, a preformed substantially hooked-shaped from section that has one end integrally connected to the front end of the main section so as to fit around the front edge and a part of the bottom portion of the step near the front edge, and a rear section that has one end integrally connected to the rear end of the main section. This design does not work for interior stairs, where it is not possible to wrap the pad around the treads.
For the forgoing reasons, there is a need for individual stair carpets that affix properly to the stair treads. These carpets do not put any impact on the wood of the stairs. The carpet secures in a very good way to the stairs to provide maximum safety to adults and younger children, and it also prevents people from slipping on the stairs due to the carpet. These individual stair carpets which do not affix to the stair tread in a permanent manner provides safety without damage.

### BRIEF SUMMARY OF THE INVENTION

It is an objective of the present invention to provide a carpet for individual stairs. It is another objective of the present invention to provide a carpet for individual stairs that prevents slipping from stairs. It is further objective of the present invention to provide a rug fiber and rubber backing It is yet another objective of the present invention to provide a carpet for individual stair with double tape.

It is another objective of the present invention to provide a safety stair carpet that is easy to install and replace without the aid of skillful workers, so as to save installation cost. Other objectives of the invention will become apparent to those skilled in the art once the invention has been shown and described. These objectives are not to be construed as limitations of the applicant's invention, but are merely aimed to suggest some of the many benefits that may be realized by the apparatus of the present application, and with its many embodiments.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures.

### BRIEF DESCRIPTION OF THE SEVERAL VIEWS OF THE DRAWINGS

The invention will be better understood, and objectives other than those set forth above will become apparent, when consideration is given to the following detailed description thereof.
Such description makes reference to the annexed drawings, wherein:

FIG. 1A, 1B and 1C depict different pieces of an individual staircase cover.

FIG. 2 depicts a view of a staircase with individual carpet covers.

### DETAILED DESCRIPTION OF THE INVENTION

The terminology used herein is for the purpose of describing particular embodiments only, and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element.

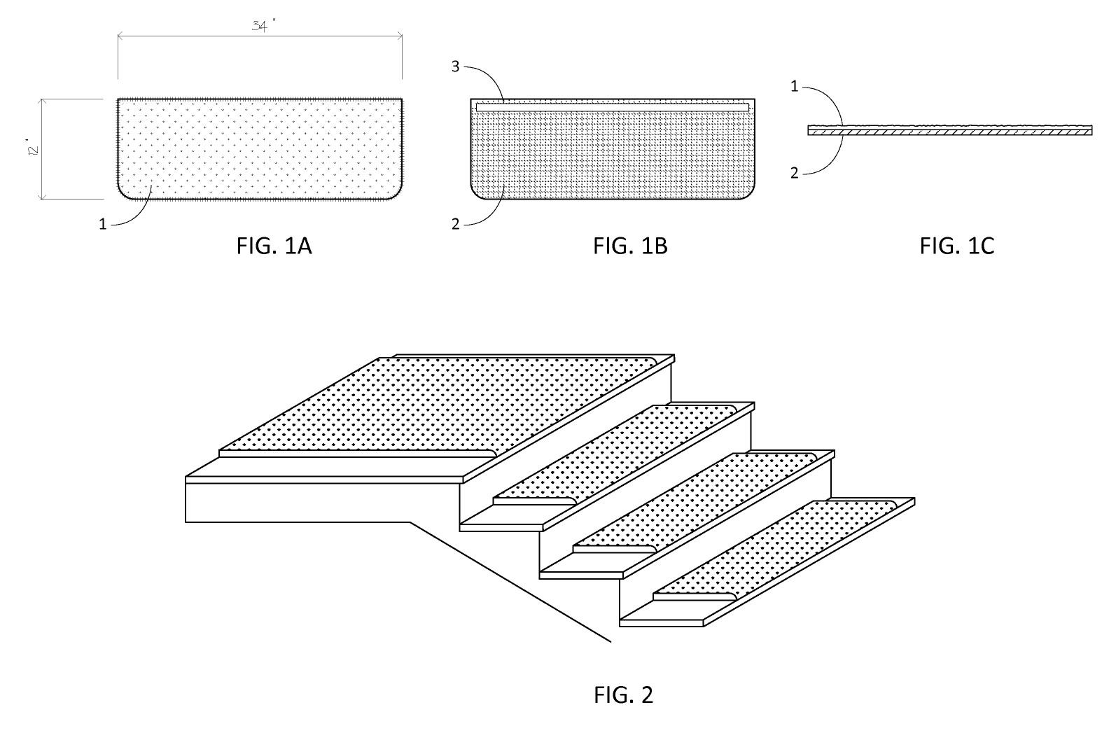

The disclosure herein is not limited by construction material(s) to the extent that such materials satisfy the structural and/or functional requirements. For example, any material may be used so long as it satisfies the rigid structural and optical functional requirements for which it is being used. In one embodiment, the lens is polycarbonate; however, other optical material of sufficient rigidity will suffice as well, if it is possible and practical for such material to support or embody the modification(s) needed to accomplish the function of the invention.
In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended description and their equivalents.
FIG. 1A depicts a top view of the carpet layer for individual stairs that has a rug as the upper portion 1, FIG. 1B depicts a bottom view of a rubber as the low portion 2 and FIG. 1C depicts a carpet with double side tape 3 and the carpet and rubber layers. Rubber backing and rug fiber would be used to make this carpet.

There is a non-skid material in the underneath portion of the carpet. The front corners of the carpet for individual stairs have a rounded shape, and the back corners have a square shape. The individual stair carpet prevents slipping from the stairs, and protects the stairs at the same time. The invention can be used for residential and commercial buildings. The individual stair case carpet pieces attach to the stairs with double tape attached on the back portion of the individual stair carpet. The individual stair case carpet pieces do not cover the staircase surface completely, and, therefore, allow one to see the aesthetic details of the stairs.

FIG. 2 illustrates the installation of the carpets with respect to individual stairs. The current invention embodies the carpet for providing safety to the users by preventing incidents of slipping by people of all age groups, such as children, adults, the elderly, etc. The primary purpose of the invention is to provide a safe means for covering the stairs with carpets that can be conveniently fixed by using double sided carpet tape (optional). Otherwise, the rubber backing provides a secure fit to the treads.
The stair tread are intended to be used in the home with an upscale, beautiful rug covering for the stairway and to be a decorative or optional soft covering rug for each tread to 15 provide décor. It can be used on holidays or on any specific days for decorative purposes on stair treads. It is to be an intended safety measure for children and older adults who may not feel secure while walking up and down from the stairs treads. Rug mat is attached with the help of glue to the entire bottom of the stair tread carpet, so it is a non-slip carpet. There is an option for the buyers to utilize double-sided tape (included) or not.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, along with any elements or limitations that may cause them to occur or to become more pronounced, are not to be construed as critical, required, or essential features of any or all of the embodiments. While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. An individual stair carpet for covering an individual step of a stair that is comprises of:
an upper portion,
a bottom portion, and
a double side tape.

2. The individual stair carpet, as claimed in claim 1, wherein said upper portion is a rug.

3. The individual stair carpet, as claimed in claim 1, wherein said upper and said bottom portions are sized to cover a major portion of the stair step.

4. The individual stair carpet, as claimed in claim 1, wherein said upper portion is a non-skid material.

5. The individual stair carpet, as claimed in claim 1, wherein said double side tape is attached to said bottom portion of the stair carpet by one side and to the stair by another side,

6. The individual stair carpet, as claimed in claim 1, wherein said upper portion and said bottom portion having rounded shape front corners.

7. The individual stair carpet, as claimed in claim 1, wherein said upper portion and said bottom portion having squared shape back corners.

8. The individual stair carpet, as claimed in claim 1, wherein said bottom portion is comprising of rubber material.

9. The individual stair carpet, as claimed in claim 1, wherein said double tape is used for fixing the individual stair carpet on the stairs.
